(19) United States
(12) Patent Application Publication
(10) Pub. No.: US 2025/0082439 A1
(43) Pub. Date: Mar. 13, 2025

(54) DENTAL FINISHING STRIP

(71) Applicant: DR. BARNEY PARADIGMS, LC, Sandy, UT (US)

(72) Inventor: Barney Todd OLSEN, Sandy, UT (US)

(21) Appl. No.: 18/885,208

(22) Filed: Sep. 13, 2024

Related U.S. Application Data
(60) Provisional application No. 63/538,166, filed on Sep. 13, 2023.

(51) Int. Cl. A61C 3/06

(52) U.S. Cl. CPC A61C 3/06

(57) ABSTRACT

The present disclosure relates to a dental finishing strip that includes an abrasive protrusion. The disclosed device can be utilized in dental restorations of interproximal cavities. The abrasive finishing strip with abrasive protrusion can remove sharp enamel edges at the proximal surface of the tooth and assist in forming a desired beveled edge at the proximal surface. Such beveled edges are conventionally difficult to form along preparation edges associated with the proximal surface of the target tooth. A beveled margin results in an improved sealing of the composite resin to the treated tooth, which in turn can increase a composite dental filling's longevity.

### CROSS-REFERENCE TO RELATED APPLICATIONS

This application claims priority to and the benefit of U.S. Provisional Application No. 63/538,166, filed Sep. 13, 2023, the entirety of which is incorporated herein by reference.

### BACKGROUND

Dentists commonly use drills to remove decay on the occlusal surfaces of teeth prior to filling a cavity. For the decay in the interproximal spaces between teeth, dentists use specialized drill bits to file away tooth decay prior to adding a composite resin filling.

Traditionally, dental professionals utilized metal amalgam fillings to restore teeth that had decayed. Amalgam fillings are strong and long lasting, often lasting for over fifteen years. However, they are metal colored and can further discolor over time. On the other hand, composite fillings can be customized to match the color of a patient's existing teeth. Composite fillings can last up to ten years or more before requiring a replacement, though inadequate sealing of the composite to the tooth surfaces can allow decay to form underneath the filling, reducing the lifespan of the filling. Patients typically prefer a white composite resin filling rather than an amalgam filling so that the filling more closely resembles a natural tooth.

Composite resin must be applied in a dry field. The filling should be sealed to the tooth surface so that bacteria, water and other contaminants cannot access the filled portion of the tooth and continue causing decay underneath the filling. When dentists prepare a target tooth for a composite resin filling, the best practice is to bevel the edges of the preparation so that there is more enamel surface area to which the resin can bond. Dentists face difficulty creating a beveled surface when preparing for a filling on the proximal surface of a target tooth without damaging adjacent teeth. Failure to create a seal results in a drastic reduction in the lifetime of a filling. Filling failures can result in dentists having to perform root canal procedures, which can be costly and inconvenient.

Typically, sanding strips are not configured to file tooth surfaces in a manner that allows for a beveled proximal enamel surface. Instead, the proximal enamel surface often ends up with an approximate 90 degree angle, which in turn can allow contamination and further decay underneath the resin fillings. This issue has resulted in subpar dental care, especially for patients with interproximal cavities. Accordingly, there is a long felt and ongoing need for improved tools for removal of dental caries present on the proximal surfaces of teeth.

### SUMMARY

The present disclosure relates to a dental finishing strip that includes an abrasive protrusion. The disclosed device can be utilized in dental restorations of interproximal cavities. The device described herein includes an abrasive finishing strip with an abrasive protrusion which can assist in forming a desired beveled proximal enamel surface. A beveled angle at the proximal enamel surface enables improved sealing of the composite resin to the prepared tooth, which in turn increases the dental filling's longevity.

In some embodiments, there is only one protrusion on the surface of the finishing strip. Other embodiments may include multiple protrusions. Some embodiments include angular protrusions, which may also include laterally extending angular projections with angular apices. Other embodiments include bulbous protrusions with curved apices.

In use, the device is placed in a patient's mouth in the interproximal space between two teeth. The protrusion faces the target tooth. The device can be moved manually in the mouth to abrade and remove sharp enamel margins. In certain embodiments, the user may move the device in a buccal-lingual direction, vertically, or a combination thereof. The abrasive protrusion can assist to form a beveled edge between the outside walls of the tooth and the newly exposed inner surfaces, particularly at the proximal surface of the target tooth.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

Various objects, features, characteristics, and advantages of the invention will become apparent and more readily appreciated from the following description of the embodiments, taken in conjunction with the accompanying drawings and the appended claims, all of which form a part of this specification. In the Drawings, like reference numerals may be utilized to designate corresponding or similar parts in the various Figures, and the various elements depicted are not necessarily drawn to scale, wherein:

FIGS. 1a and 1b illustrate an example of a conventional dental finishing strip, placed in the interproximal surface between a decaying target tooth and an adjacent tooth;

FIGS. 2a and 2b illustrates an example of a dental finishing strip with a protrusion made to fit against the contours of a target tooth;

FIG. 3a illustrates an example of a dental finishing strip with one side surface coated in an abrasive material;

FIG. 3b illustrates an example of a dental finishing strip with both side surfaces coated in an abrasive material;

FIGS. 4a-4c illustrate differing views of a sample protrusion disposed on an abrasive side surface of the dental finishing strip, where the protrusion can be oriented at various angles in relation to the longitudinal axis of the finishing strip;

FIGS. 5a-5c illustrate an example of a single, angular protrusion disposed on an abrasive side surface of the dental finishing strip, where the protrusion can be oriented at various angles in relation to the longitudinal axis of the finishing strip;

FIGS. 6a-6c illustrate an example of a single, angular protrusion containing angular projections disposed on an abrasive side surface of the dental finishing strip, where the protrusion can be oriented at various angles in relation to the longitudinal axis of the finishing strip;

FIG. 7a-7c illustrates an example of a single protrusion, containing both an angular and bulbous component, disposed on an abrasive side surface of the dental finishing strip, where the protrusion can be oriented at various angles in relation to the longitudinal axis of the finishing strip;

FIG. 8a-8c illustrates an example of a single protrusion, containing both an angular and bulbous component, disposed on an abrasive side surface of the dental finishing strip, where the protrusion can be oriented at various angles in relation to the longitudinal axis of the finishing strip;

FIG. 9 illustrates an example of a finishing strip with multiple protrusions disposed on one side surface of the strip;

FIG. 10 illustrates a side view of a conventionally prepared tooth, showing a typical 90-degree angle at the proximal enamel surface;

FIG. 11 illustrates a side view of a conventionally prepared tooth, showing a typical 90-degree angle at the occlusal enamel surface;

FIG. 12 illustrates a side view of a tooth prepared by creating beveled edges on the proximal enamel surface.

### DETAILED DESCRIPTION

### Introduction

The following detailed description can solve one or more of the problems discussed above. The dental finishing strip described below can be used by dental professionals who perform dental restorations on patients suffering from cavities. It allows for the creation of a beveled proximal enamel surface when preparing a target tooth for a dental restoration. The beveled surface allows for the creation of a better seal (relative to a 90-degree proximal enamel edge) between the filling material and the surface of teeth than could be achieved by current devices. A more effective seal enables a longer lasting filling which allows the patient to avoid repeated fillings or more invasive procedures in the future. By adding an abrasive protrusion to a current dental finishing strip, the device can allow dental professionals to create beveled proximal enamel surfaces at the edges of interproximal cavities.

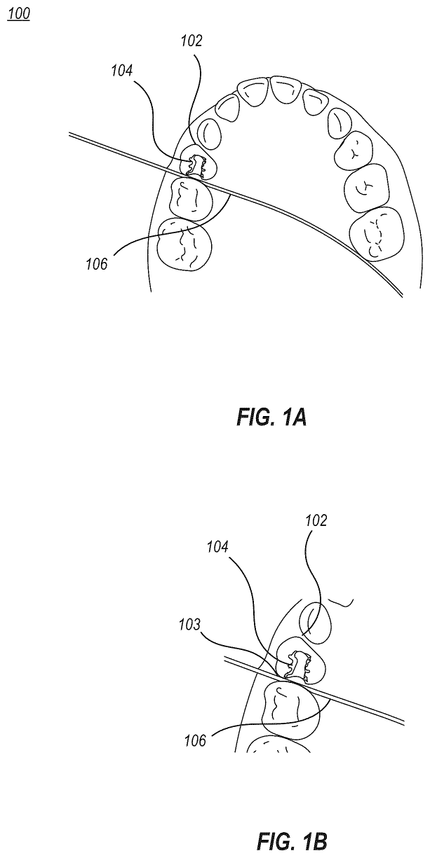

FIGS. 1a and 1b illustrate a typodont model 100 where a primary molar target tooth 102 has been prepared for a dental restoration. Portions of both the proximal and occlusal surfaces have been removed. A conventional dental finishing strip 106 has been placed in the interproximal space between the prepared target tooth 102 and an adjacent tooth, where the abrasive surface is facing the proximal surface of the target tooth 102. The conventional dental finishing strip 106 does not contain any protrusions, and there is a gap 103 between the finishing strip 106 and the cavosurface margins of the target tooth 102. FIGS. 1a and 1b illustrate that conventional finishing strips are not configured to create the desired obtuse cavosurface margin angles (i.e., are not configured to form beveled proximal enamel surfaces).

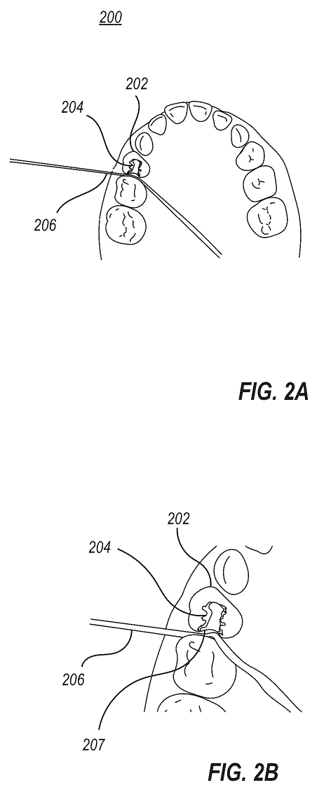

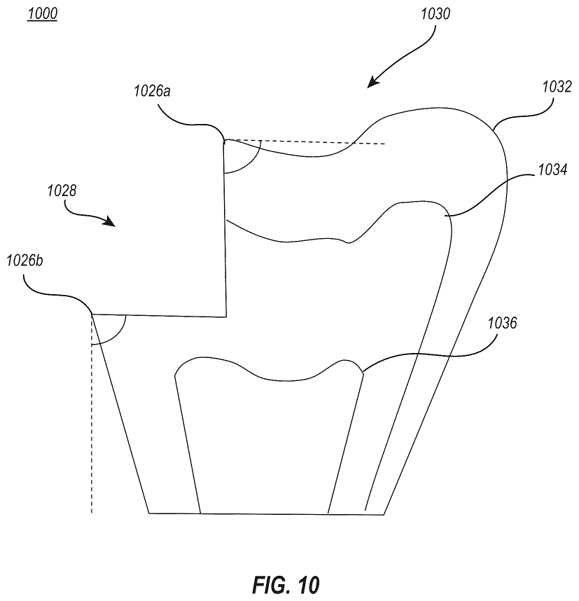

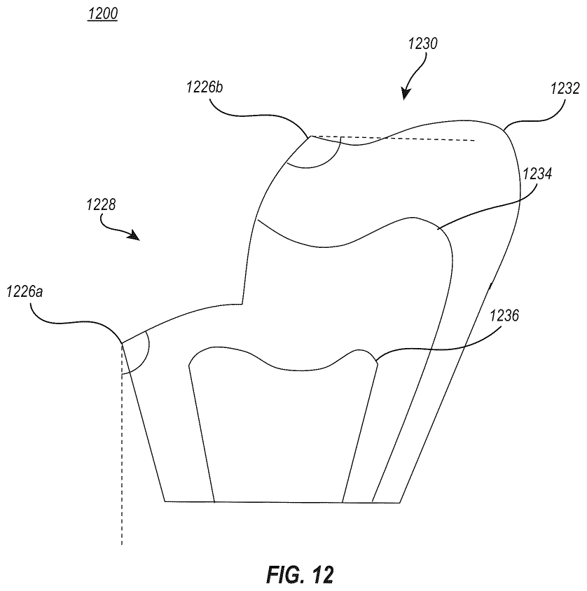

FIG. 2 illustrates a typodont model and target tooth 202. A dental finishing strip 202 according to the present disclosure has been placed in the interproximal space between the target tooth 202 and an adjacent tooth, where the abrasive surface faces the proximal surface of the target tooth. In this embodiment, the dental finishing strip 206 includes a protrusion 207. The protrusion eliminates the gap seen in the previous figure and is better able to contact the necessary cavosurface margins to perform more effective finishing of the enamel surface prior to filling the cavity. As described in more detail herein (see FIGS. 10 and 12), the finishing strip 206, by way of protrusion 207, is better able to abrade the enamel edges in a beveled fashion and thereby assist in forming the desired shape.

### Example Embodiments

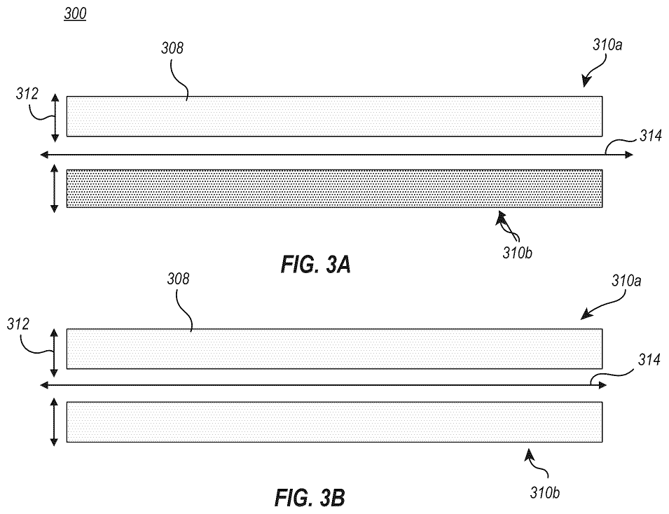

FIG. 3a illustrates an example of a conventional dental finishing strip 300. The dental finishing strip 300 includes a side surface 310a substantially or entirely coated in an abrasive material 308 and an opposite side surface 310a that is substantially or entirely uncoated and omits abrasive material. The strip includes a length defining a longitudinal axis 314 and a width defining a lateral axis 312 (also referred to herein as vertical axis 312). As used herein, the term “vertical axis” is synonymous with the term “lateral axis.” The term “vertical axis” is used to indicate that the axis extends along a superior-inferior direction when the strip 300 is placed in the interproximal space between teeth. Of course, this need not correspond to “vertical” as defined by gravity.

FIG. 3a illustrates an example of a dental finishing strip where only one side surface is coated in abrasive material 308. FIG. 3b illustrates an example of a dental finishing strip with both side surfaces 310a and 310b substantially or entirely coated in an abrasive material 308. The dental finishing strips disclosed herein can be formed from any material or combination of materials that can be safely used in dental applications. Examples of suitable base materials include metal, plastic and other polymers, carbon fiber materials, and other materials suitable for dental use. A suitable abrasive material can be embedded or attached to one or both sides of the strip.

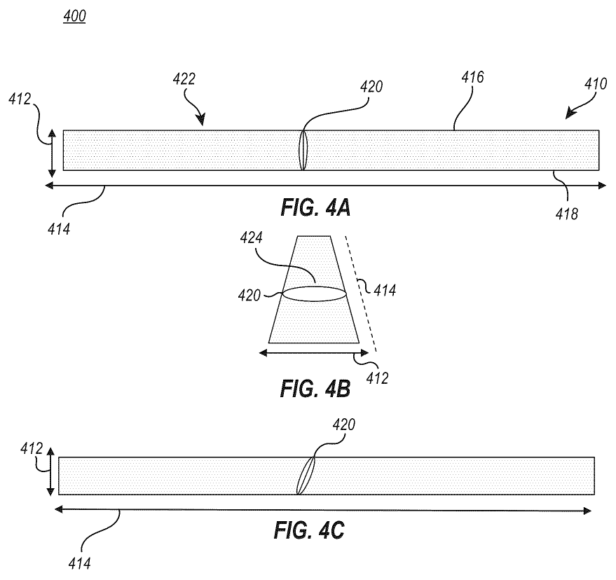

FIG. 4a illustrates a top-down view of a dental finishing strip 400 with a first edge 416 and second edge 418. This embodiment includes an abrasive protrusion 420 disposed on a side surface substantially or entirely coated in abrasive material. The protrusion extends from the first edge 416 to the second opposing edge 418 along the vertical axis 412 of the side surface 410. The protrusion 420 is oriented transverse (e.g., perpendicular) to the longitudinal axis 414 of the side surface 410. FIG. 4b illustrates a perspective view of the same finishing strip 400. As shown, the protrusion 420 is rounded with a curved apex 426 at its highest point.

FIG. 4c illustrates another top-down view of a different configuration of dental finishing strip 400 in which protrusion 420 is oriented at an angle transverse to both the longitudinal 414 and vertical 412 axes of the strip (e.g., the protrusion has a “diagonal” orientation).

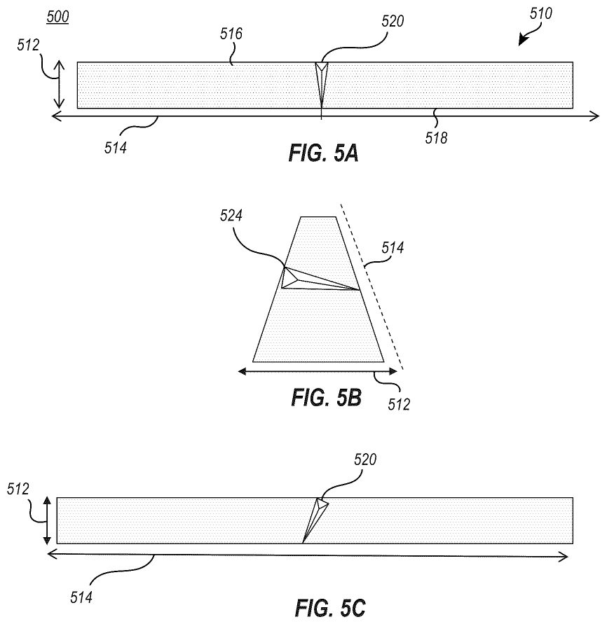

FIG. 5a illustrates a top-down view of a dental finishing strip 500 which includes a protrusion 520 disposed on a side surface 510 substantially or entirely coated in abrasive material. The protrusion extends from the first edge 516 to the second opposing edge 518 down the vertical axis 512 of the side surface 510. In this configuration, the protrusion 520 is oriented perpendicular to the longitudinal axis 514 of the side surface 510. FIG. 5b illustrates a perspective view of the finishing strip 500.

In this embodiment, protrusion 520 contains an angular apex 524 at its highest point. In addition, as shown, protrusion 520 can include a tapered width and/or height as it extends from the first edge 516 to the opposing second edge 518 along the vertical axis 512 of the side surface 510. That is, the protrusion 520 can be wider and/or higher near the first edge 516 and get progressively narrower and/or lower toward the second edge 518. A protrusion with such a shape can be beneficial in preparing a target tooth with a similarly shaped cavity for a filling. For example, when the narrower/shorter portion of the protrusion 520 (the portion at or near edge 516) is oriented toward the gumline, with the wider/higher portion oriented “upwards,” the tapered shape can help to form a beveled surface in the proximal enamel surface of the target tooth.

FIG. 5c illustrates another top-down view of dental finishing strip 500 in which the protrusion 520 is oriented at an angle transverse to both the longitudinal 514 and vertical 512 axes of the strip (e.g., the protrusion has a “diagonal” orientation).

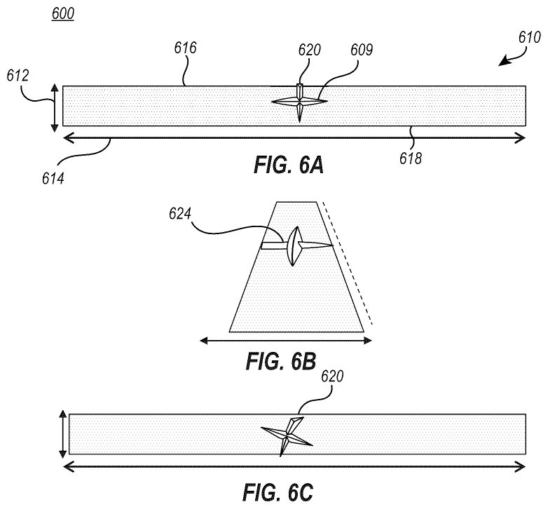

FIG. 6a illustrates a top-down view of a dental finishing strip 600 which includes a protrusion 620 disposed on a side surface 610 substantially or entirely coated in abrasive material. The protrusion extends from the first edge 616 to a second opposing edge 618 along the vertical axis 612 of the side surface 610. The protrusion 620 also includes one or more angular projections 609 extending therefrom. The protrusion 620 is oriented transverse (e.g., substantially perpendicular) to the longitudinal axis 614 of the side surface 610. FIG. 6b illustrates a perspective view of the same finishing strip. In this embodiment, protrusion 620 contains an angular apex 624 at its highest point.

FIG. 6c illustrates a top-down view of dental finishing strip 600 in which protrusion 620 is oriented at an angle transverse to both the longitudinal 614 and vertical 612 axes of the strip (e.g., the protrusion has a “diagonal” orientation).

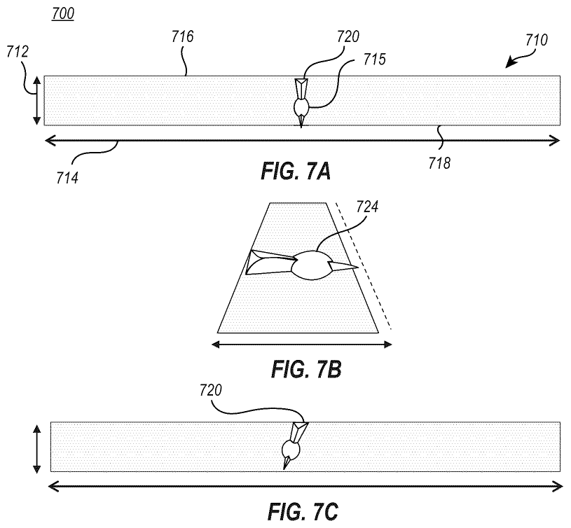

FIG. 7a illustrates a top-down view of a dental finishing strip 700 which includes a protrusion 720 disposed on a side surface 710 substantially or entirely coated in abrasive material. The protrusion 720 extends from a first edge 716 to a second opposing edge 718 of the width of the side surface. In this embodiment, the protrusion has a bulbous, elliptical component 715 that defines the apex 724, or highest point, of the protrusion 720. The non-bulbous portion of the protrusion 720 has a tapered shape similar to the embodiment shown in FIGS. 7a-7c. The protrusion is oriented transverse (e.g., perpendicular) to the longitudinal axis 714 of the side surface 712. FIG. 7b illustrates a perspective view of the same finishing strip. In this embodiment, protrusion 720 contains a curved apex 724 at its highest point.

FIG. 7c illustrates a top-down view of a dental finishing strip 700 in which protrusion 720 is oriented at an angle transverse to both the longitudinal 714 and vertical 712 axes of the strip (e.g., the protrusion has a “diagonal” orientation).

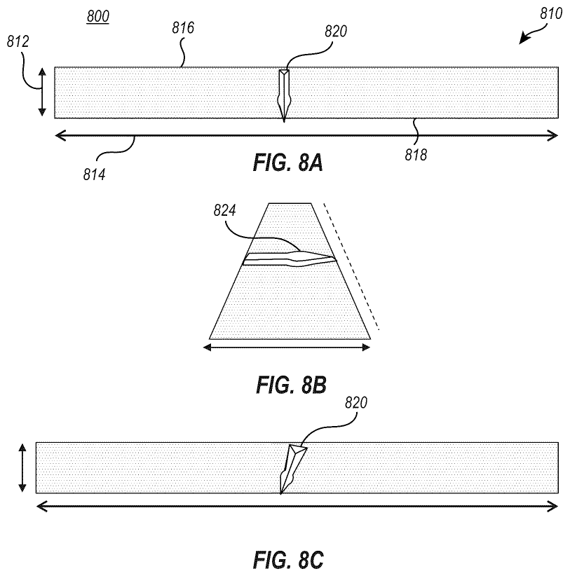

FIG. 8a illustrates a top-down view of a dental finishing strip 800 which includes a protrusion 820 disposed on a side surface 810 substantially or entirely coated in abrasive material. The protrusion extends from a first edge 816 to a second opposing edge 818 along the vertical axis 812 of the side surface. Similar to the embodiment of FIGS. 8a to 8c, this embodiment contains a bulbous, elliptical component that defines the apex 824 of the protrusion 820. The protrusion is oriented transverse (e.g., perpendicular) to the longitudinal axis 814 of the side surface. FIG. 8b illustrates a perspective view of the same finishing strip. In this embodiment, protrusion 820 contains a curved apex 824 at its highest point.

FIG. 8c illustrates a top-down view of dental finishing strip 800 in which protrusion 820 is oriented at an angle transverse to both the longitudinal 814 and vertical 812 axes of the strip (e.g., the protrusion has a “diagonal” orientation).

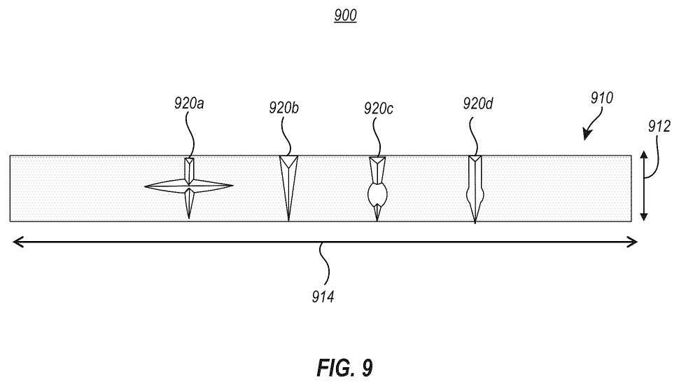

FIG. 9 illustrates a dental finishing strip 900 that defines a plurality of protrusions 920a, 920b, 920c, and 920d disposed on one side surface 910. In order for each protrusion to be effectively used by a dental professional, the protrusions are preferably spaced apart from each other by at least one centimeter. A dental finishing strip may include multiple protrusions wherein each protrusion is substantially similar, or may include multiple protrusions wherein at least one protrusion is different from at least one other protrusion. Having multiple protrusions of different shapes provides the dental professional with multiple options on the same strip, which may be beneficial when trying to find the most suitable shape for a particular target tooth.

### Example Methods of Use

FIG. 10 illustrates a side, cross-sectional view of a target tooth 1000 containing an enamel layer 1032, dentin layer 1034, and a pulp layer 1036. The portion of the tooth suffering decay often spans both occlusal 1030 and proximal 1028 surfaces of the tooth. In this preparation, the enamel edges 1026a and 1026b formed between the enamel 1032 and the exposed walls of the prepared surfaces meet at 90-degree angles with respect to the horizontal and vertical axes. In other words, the enamel edges 1026a and 1026b remaining after removal of decayed tissue are relatively “sharp.” The enamel edge 1026a borders the occlusal surface 1030 and can be readily finished and beveled using an embodiment of the finishing strip to avoid risk of damage to the adjacent tooth. Similarly, the other enamel edge 1026b on the proximal surface can be finished and beveled using an embodiment of the finishing strip to avoid the risk of damage to the proximal surface of an adjacent tooth.

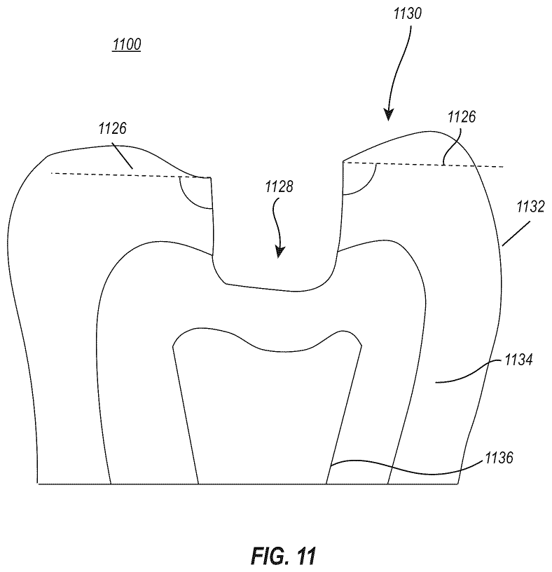

FIG. 11 illustrates a side, cross-sectional view of a target tooth 1100 containing an enamel layer 1132, dentin layer 1134, and pulp layer 1136. The portion of the tooth suffering decay spans the occlusal 1130 surface of the tooth. In this preparation, the enamel edges 1126a and 1126b formed between the enamel 1132 and the exposed walls of the prepared surfaces meet at 90-degree angles with respect to the horizontal and vertical axes. In other words, the enamel edges 1126a and 1126b remaining after removal of decayed tissue are relatively “sharp.” The enamel edge 1126a borders the occlusal surface 1130 and can be readily finished and beveled using an embodiment of the finishing strip to avoid risk of damage to the adjacent tooth. FIG. 11 illustrates that while most implementations of the disclosed dental finishing strips will be in the context of interproximal cavities, they may also be utilized to refine the finishing of other types of cavities such as pit/fissure cavities.

The disclosed dental finishing strips can be beneficially used to form beveled edges on the enamel surface of the preparation. In contrast to the conventional preparation of interproximal cavities as shown in FIG. 10, FIG. 12 illustrates beveled surfaces at the edges 1226a and 1126b of the prepared surface. This results in a tighter seal between the filling and target tooth 1200, extending the life and success of the filling.

### Additional Terms & Definitions

While certain embodiments of the present disclosure have been described in detail, with reference to specific configurations, parameters, components, elements, etcetera, the descriptions are illustrative and are not to be construed as limiting the scope of the claimed invention.

Furthermore, it should be understood that for any given element of component of a described embodiment, any of the possible alternatives listed for that element or component may generally be used individually or in combination with one another, unless implicitly or explicitly stated otherwise.

In addition, unless otherwise indicated, numbers expressing quantities, constituents, distances, or other measurements used in the specification and claims are to be understood as optionally being modified by the term “about.” When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition. At the very least, and not as an attempt to limit the application of the doctrine of equivalents to the scope of the claims, each numerical parameter should be construed in light of the number of reported significant digits and by applying ordinary rounding techniques.

Any headings and subheadings used herein are for organizational purposes only and are not meant to be used to limit the scope of the description or the claims.

It will also be noted that, as used in this specification and the appended claims, the singular forms “a,” “an” and “the” do not exclude plural referents unless the context clearly dictates otherwise. Thus, for example, an embodiment referencing a singular referent (e.g., “widget”) may also include two or more such referents.

The embodiments disclosed herein should be understood as comprising/including disclosed components, and may therefore include additional components not specifically described. Optionally, the embodiments disclosed herein consist of or consist essentially of the disclosed components. For example, embodiments may be essentially free or completely free of components that are not specifically described. That is, non-disclosed components may optionally be completely omitted or essentially omitted from the disclosed embodiments.

It will also be appreciated that embodiments described herein may also include properties and/or features (e.g., ingredients, components, members, elements, parts, and/or portions) described in one or more separate embodiments and are not necessarily limited strictly to the features expressly described for that particular embodiment. Accordingly, the various features of a given embodiment can be combined with and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include such features.

1. A dental finishing strip for preparing a cavity of a tooth for a composite filling, the dental finishing strip comprising:
an elongated strip of material that includes a length defining a longitudinal axis and a width defining a vertical axis, wherein the length and width define side surfaces extending from a first end to a second end along the longitudinal axis and extending from a first edge to a second edge along the vertical axis;
one or both side surfaces including abrasive material; and
a first abrasive protrusion disposed on at least one of the side surfaces.

2. The dental finishing strip of claim 1, wherein one or both side surfaces are substantially entirely coated in the abrasive material

3. The dental finishing strip of claim 1, wherein the first abrasive protrusion extends from a first edge to an opposing second edge along the width of the side surface.

4. The dental finishing strip of claim 1, further comprising one or more additional abrasive protrusions.

5. The dental finishing strip of claim 4, wherein all abrasive protrusions are disposed on the same side surface.

6. The dental finishing strip of claim 1, wherein the first abrasive protrusion extends in a direction substantially perpendicular to the longitudinal axis.

7. The dental finishing strip of claim 1, wherein the first abrasive protrusion comprises a curved apex.

8. The dental finishing strip of claim 1, wherein the first abrasive protrusion comprises an angular apex.

9. The dental finishing strip of claim 1, wherein multiple protrusions are longitudinally separated from each other by at least a centimeter.

10. The dental finishing strip of claim 1, wherein the first abrasive protrusion is oriented at a transverse angle relative to the longitudinal and vertical axes.

11. The dental finishing strip of claim 1, wherein the first abrasive protrusion further comprises one or more projections extending therefrom.

12. The dental finishing strip of claim 1, wherein the width and/or height of the first abrasive protrusion is greater at a point at or near the first edge of the vertical axis than at a point at or near the second edge of the vertical axis.

13. The dental finishing strip of claim 1, wherein the width and/or height of the first abrasive protrusion tapers from a point at or near the first edge to a point at or near the opposing second edge.

14. The dental finishing strip of claim 1, wherein the first abrasive protrusion comprises a bulbous and/or curved component.

15. The dental finishing strip of claim 1, wherein the first abrasive protrusion comprises an angular component.

16. A method for preparing a cavity of a target tooth for a composite filling, the method comprising:
providing a dental finishing strip of claim 1;
contacting the strip with a target tooth such that the abrasive protrusion faces a decaying portion of the target tooth;
moving the strip to cause the abrasive protrusion to abrade the surface of the target tooth and thereby removing a decayed portion therefrom.

17. The method of claim 16, wherein the dental finishing strip is moved in a buccal-lingual direction and/or in a vertical direction against a decaying portion of the target tooth.

18. The method of claim 16, wherein contacting the strip with the target tooth comprises inserting the strip into the interproximal space between two adjacent teeth and wherein moving the strip causes the abrasive protrusion to abrade the proximal surface of the target tooth and thereby remove a decayed portion therefrom.

19. The method of claim 16, wherein the shape and orientation of the protrusion of the selected finishing strip substantially corresponds to the shape of the decayed portion of the target tooth.

20. The method of claim 16, wherein moving the strip creates an obtuse cavosurface margin angle between a removed portion and a surface on the target tooth.
